(19) United States
(12) Patent Application Publication
(10) Pub. No.: US 2026/0220897 A1
(43) Pub. Date: Jul. 30, 2026

(54) Selective Inclusion of Images in a Three-Dimensional Model of a Scene

(71) Applicant: Telefonaktiebolaget LM Ericsson (publ), Stockholm (SE)

(72) Inventors: André Mateus, Stockholm (SE); Mercedes García Salguero, Stockholm (SE); Elijs Dima, Stockholm (SE); Sigurdur Sverrisson, Stockholm (SE)

(21) Appl. No.: 19/157,947

(22) PCT Filed: Mar. 30, 2023
(86) PCT No.: PCT/EP2023/058221

§ 371 Date: Aug. 19, 2025

(51) Int. Cl. G06T 19/00; G06T 7/70

(52) U.S. Cl. CPC G06T 19/00; G06T 7/70; G06T 2207/30244

(57) ABSTRACT

There is provided techniques for determining whether or not to include an image in a 3D model of a scene. A method is performed by an image processing device. The method is repeatedly performed for images obtained from an image scan of the scene that have not already been included in the 3D model. The method for each iteration k=1:K comprises obtaining a pose as determined for an image selected for iteration k and data used to compute the pose for the selected image, and determining, depending on whether a value for the image as computed as a function of the pose and the data for the selected image fulfils a quality criterion or not, whether, and when, to include the selected image in the 3D model. The selected image is included in the 3D model for iteration k when the value fulfils the quality criterion. The selected image is not included in the 3D model for iteration k when the value fails to fulfil the quality criterion.

### TECHNICAL FIELD

Embodiments presented herein relate to a method, an image processing device, a computer program, and a computer program product for determining whether or not to include an image in a three-dimensional model of a scene.

### BACKGROUND

In general terms, reconstruction of three-dimensional (3D) images involves building a dense 3D model (e.g., a point cloud, a mesh, or the like) of an environment. 3D reconstruction can be performed as part of e.g., creating digital twin representations, or up-to-date 3D maps and models, of any particular location or object. Two approaches to address 3D reconstruction will be disclosed next.

A first approach is focused on the exploitation of 3D scanners, arranged to scan the environment and to create one dense model per scanning position. After scanning many positions in the environment, the scans are stitched together to obtain the final dense 3D model. 3D scanners are commonly expensive and have a high scan time (such as in the order of 5 minutes per scan), which implies a lot of man hours needed for a qualified operator for all necessary scans of the environment to be completed.

A second approach relies on using two-dimensional (2D) images from depicting the environment to build a sparse 3D model and to obtain the image positions with respect to each other. Then, the sparse 3D model is combined with the pose (representing the position and orientation of the camera) for each image in a densification process, which as the name indicates, increases the density, i.e., the number of points per unit of volume, in the sparse 3D model, thus yielding a dense 3D model. Examples of such methods are presented in Schonberger, Johannes L., and Jan-Michael Frahm: “Structure-from-motion revisited”, in Proceedings of the IEEE conference on computer vision and pattern recognition, 2016, in OpenSfM. https://github.com/mapillary/OpenSfM (valid as of 21 Mar. 2023), and in Moulon, Pierre, et al. “Openmvg: Open multiple view geometry”, in Proceedings of the International Workshop on Reproducible Research in Pattern Recognition, Springer, Cham, 2016.

A block diagram for creating the sparse 3D model and poses, as part of the second approach, is provided in FIG. 1.

A set of 2D images no is fed as input to a feature extractor block 120 configured to, in each 2D image detect and describe points of interest (e.g., scale-invariant feature transform (SIFT) keypoints), or features, in the images. A feature matcher block 130 is configured to, based on the detected points of interest, or features, for each image search for potential matches in all the other images. A scene graph initializer block 140 is configured to create a scene graph (SG). The nodes of the SG contain the 2D images and their keypoints, and its edges have the matching keypoints between the connected images and the two-view geometry (Epipolar geometry). A sparse 3D model initializer block 150 is configured to select the edge of the SG with the highest number of valid matching keypoints as the initial pair of 2D images, and the matching keypoints of theses 2D images are triangulated to create the initial sparse 3D model. An incremental structure-from-motion (SfM) block 160 is configured to apply an iterative process involving: selecting the next 2D image to be added to the sparse 3D model, for example based on the number of co-visible 3D points, solving the Perspective-n-Point (PnP) problem, which provides the pose for the new 2D image; triangulating new co-visible 2D points between the new 2D image and the 2D images already registered in the 3D model; and bundle adjustment (BA), which involves optimizing the poses and 3D points that minimize the reprojection error. The end-result of this iterative process is a sparse 3D model and poses 170.

Aspects of the PnP problem will be disclosed next. After solving the PnP problem there are two possible outcomes. The first outcome is that the PnP solver failed to obtain a solution (i.e., fails to identify the pose for the selected image) and the selected image is discarded. In the second outcome, the solution (i.e., the pose for the selected image) of the PnP is used to triangulate new 3D points, causing the BA process to be triggered.

However, there is no evaluation of the quality of the PnP solution due to the non-convexity of the problem in most cases. This may lead to incorrect solutions, and thus poses, being accepted, which will introduce incorrect 3D points in the sparse 3D model. In turn, the error will propagate to the next images to be inserted in the 3D model.

The BA step can help overcome this, but the issue is highly non-linear, and the incorrect 3D points can lead the optimization to fall in local minima, which can be far from the correct solution. Moreover, although the solution can be good and not introduce high errors into the 3D model, that BA cannot overcome, the solution can still be far from the global minimum, which in most cases will lead the BA to require more iterations to obtain a solution, and thus making the reconstruction process slower.

Hence, there is still a need for improved creation of sparse 3D models and poses.

### SUMMARY

An object of embodiments herein is to address the above issues to provided improved creation of sparse 3D models and poses.

A particular object is to address issues with how the PnP problem is solved.

A particular object is to evaluate the quality of the PnP solution as part of creating sparse 3D models and poses.

A particular object is to determine when and if to include an image in the 3D model.

According to a first aspect there is presented a method for determining whether or not to include an image in a 3D model of a scene. The method is performed by an image processing device. The method is repeatedly performed for images obtained from an image scan of the scene that have not already been included in the 3D model. The method for each iteration k=1:K comprises obtaining a pose as determined for an image selected for iteration k and data used to compute the pose for the selected image, and determining, depending on whether a value for the image as computed as a function of the pose and the data for the selected image fulfils a quality criterion or not, whether, and when, to include the selected image in the 3D model. The selected image is included in the 3D model for iteration k when the value fulfils the quality criterion. The selected image is not included in the 3D model for iteration k when the value fails to fulfil the quality criterion.

According to a second aspect there is presented an image processing device for determining whether or not to include an image in a 3D model of a scene. The image processing device comprises processing circuitry. The processing circuitry is configured to cause the image processing device to repeatedly in iterations k=1:K for images obtained from an image scan of the scene that have not already been included in the 3D model obtain a pose as determined for an image selected for iteration k and data used to compute the pose for the selected image, and determine, depending on whether a value for the image as computed as a function of the pose and the data for the selected image fulfils a quality criterion or not, whether, and when, to include the selected image in the 3D model. The selected image is included in the 3D model for iteration k when the value fulfils the quality criterion. The selected image is not included in the 3D model for iteration k when the value fails to fulfil the quality criterion.

According to a third aspect there is presented a computer program for determining whether or not to include an image in a 3D model of a scene. The computer program comprises computer code which, when run on processing circuitry of an image processing device, causes the image processing device to, repeatedly in iterations k=1:K for images obtained from an image scan of the scene that have not already been included in the 3D model, perform actions. One action comprises the image processing device to obtain a pose as determined for an image selected for iteration k and data used to compute the pose for the selected image. One action comprises the image processing device to determine, depending on whether a value for the image as computed as a function of the pose and the data for the selected image fulfils a quality criterion or not, whether, and when, to include the selected image in the 3D model. The selected image is included in the 3D model for iteration k when the value fulfils the quality criterion. The selected image is not included in the 3D model for iteration k when the value fails to fulfil the quality criterion.

According to a fourth aspect there is presented a computer program product comprising a computer program according to the third aspect and a computer readable storage medium on which the computer program is stored. The computer readable storage medium could be a non-transitory computer readable storage medium.

Advantageously, these aspects provide efficient creation of sparse 3D models and poses without experiencing the above identified issues.

Advantageously, these aspects resolve the issues with how the PnP problem is solved.

Advantageously, these aspects enable the quality of the PnP solution to be evaluated as part of creating sparse 3D models and poses.

Advantageously, these aspects can be used to determine when and if to include an image in the 3D model.

Advantageously, these aspects avoid inserting images with incorrect pose estimates in the 3D model, thereby preventing error propagation when the next image is considered for insertion.

Advantageously, these aspects prevent solutions that are far from the correct solution to be immediately inserted in the 3D model, and thus prevent BA to have to run for a high number of iterations and reduce the risk of the BA not reaching the optimum solution.

Advantageously, these aspects enable an image to be tested for inclusion in the 3D model more than once (in case its pose estimate fails to be certified the first time the image is tested for inclusion in the 3D model).

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a block diagram for creating a sparse 3D model and poses according to an example;

FIG. 2 is a block diagram of an incremental SfM block according to an embodiment;

FIGS. 3 and 4 are flowcharts of methods according to embodiments;

FIG. 5 is a schematic diagram showing functional units of an image processing device according to an embodiment;

FIG. 6 is a schematic diagram showing functional modules of an image processing device according to an embodiment; and

FIG. 7 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved creation of sparse 3D models and poses.

The embodiments disclosed herein therefore relate to techniques for determining whether or not to include an image in a 3D model of a scene. In order to obtain such techniques there is provided an image processing device, a method performed by the image processing device, a computer program product comprising code, for example in the form of a computer program, that when run on an image processing device, causes the image processing device to perform the method.

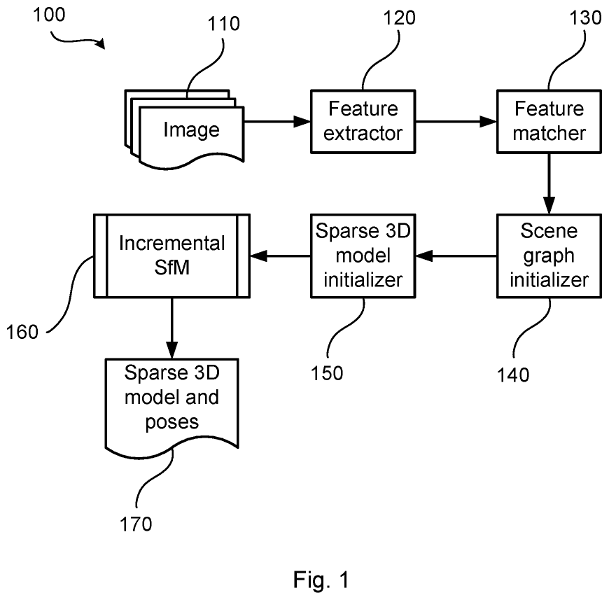

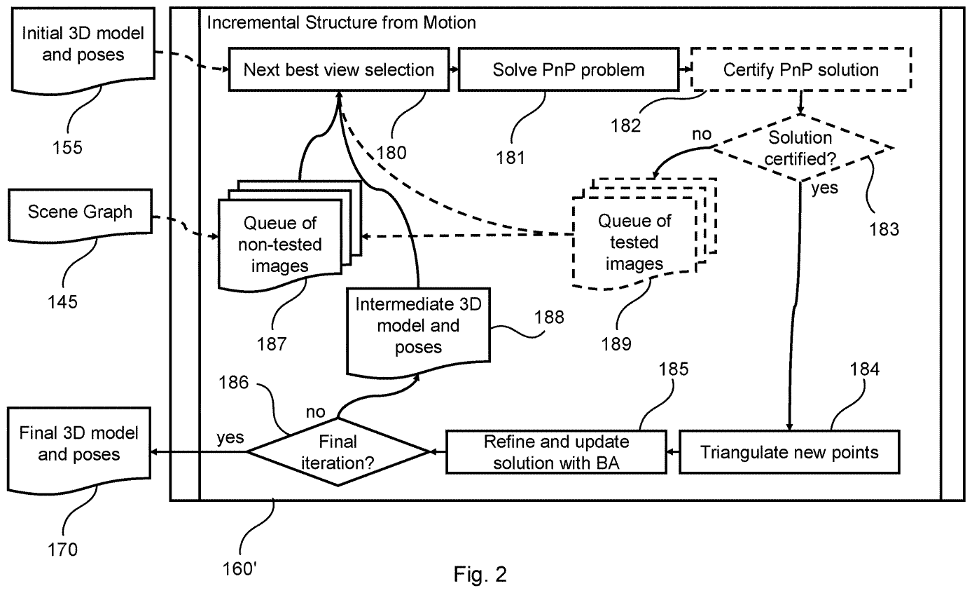

Reference is next made to the block diagram of FIG. 2 which shows an embodiment of an incremental SfM block 160′ to replace the SfM block 160 in FIG. 1. The input to the SfM block 160′ is an initial 3D model and poses 155 as well as a scene graph 145. The output produced by the SfM block 160′ is a final 3D model and poses 170.

The next best view selection block 180 is configured to select the next image for the 3D model from the queue of non-tested images 187. In some examples, the selection is based on the number of co-visible 3D points. In this way the next image will be the one that observes the most 3D points in the current 3D model. In some examples, the selection is based on the number of co-visible 2D points. This criterion favors images that see the most 2D points to add to the 3D model. In some examples, the selection is based on the distribution of 2D and/or 3D points in the image. PnP is a non-linear problem, and its solutions tend to hold only locally, so if the 2D/3D points are close together the solution may only hold in that area of the image, whereas images with a good, wide distribution of 2D/3D points are more likely to lead to a solution that holds for the whole image. In some examples, the selection is based on a combination of two or more of the above metrics. The 3D model here refers to either the initial 3D model and poses 155 (for the first iteration) or the intermediate 3D model and poses 188 (for all remaining iterations).

The solve PnP problem block 181 is configured to solve the PnP problem, and thus to determine the pose for the 2D image selected by the next best view selection block 180. According to some examples, determining the pose involves minimizing some metric on the angle and/or distance between the observations (seeing as reprojection rays) and the 3D points. According to some examples, the pose is determined by considering the distance between the 3D line corresponding to the reprojection ray of the observed 2D point and the 3D point. According to some examples, the pose is determined by minimizing the reprojection error, i.e., minimize the distance between the observed 2D point and the predicted position of the 3D point projected to the image, given the current pose estimation T=(R, t), where R corresponds to the rotation matrix and t is a vector corresponding to the translation.

The certify PNP solution block 182 is configured to, given the PnP solution (i.e., the pose of the selected image as determined by the solve PnP problem block 181) and the data, i.e., the pairs of observations (2D image points), and corresponding 3D points, supporting the PnP solution, determine whether this solution is the global optimum or not. In some examples, the decision is made via the least eigenvalue λₘᵢₙ of the Hessian, which depends on the pose and the data used to determine the pose for the selected image. The Hessian is related to a convex relaxation of the given problem, known as the dual problem. In some examples, to consider the solution as optimal, λₘᵢₙ is required to be larger than a fixed, negative threshold value τ₁.

The solution certified check block 183 is configured to check the output of the certify PNP solution block 182. If the certify PNP solution block 182 indicates that an optimum solution has been found, then the triangulate new points block 184 is entered. Else, the selected image is flagged for potential insertion at a later iteration and then put in the queue of tested images 189, and another image is selected by the next best view selection block 180. The certify PNP solution block 182 and the solution certified check block 183 can thereby be configured to validate the solution and to assess if the solution is close to the global minimum. If the PnP solution is certifiable, the Incremental SfM process for the selected image continues with the triangulate new points block 184 and if not, instead of simply discarding the selected image, the selected image is inserted into the queue of tested images 189 so that the image can be tested for inclusion in the 3D model at a later stage, after the 3D model has grown, i.e., when at least one other image has been inserted in the 3D model.

The triangulate new points block 184 is configured to triangulate new co-visible 2D points between the new 2D image and the 2D images already registered in the 3D model, for example by checking which 2D keypoints in the newly registered image are shared with the images already in the 3D model, but have not been yet added to the 3D model, due to previously only being visible by a single image for example.

The refine and update solution with BA block 185 is configured to optimize the poses and 3D points that minimize the reprojection error, for example by finding the 3D points in the point cloud P, and the poses Tᵢ, with i=1, . . . , m, and m being the number of images that minimize the reprojection of all 3D points to all images which observe it.

The final iteration check block 186 is configured to check if the current iteration is the last one. If yes, then the current 3D model and poses are produced as output from the incremental SfM block 160′. Else, the current 3D model and poses represent an intermediate 3D model and poses 188.

An option as illustrated in FIG. 2 is thus to keep two queues; one queue of non-tested images 187 and another queue of tested images 189, but whose registration (i.e., PnP solution was not certified) failed, as determined by blocks 182 and 183.

In some examples, once an image has been entered into the queue of tested images 189, the next image will be drawn from the queue of non-tested images 187 until at least one new image has been inserted in the 3D model (i.e., until block 184 has been entered). The next image can then be selected either from the queue of non-tested images 187 or the queue of tested images 189. In some examples, each image in the queue of tested images 189 is only removed from that queue after a certain number k of new (non-tested) images have been added to the 3D model. In some examples, the consideration to use an image from the queue of tested images 189 can be based on the addition of 3D points to the point cloud P which fall in a different area of the image, that the previous 3D points that lead to a non-certified solution.

The consideration can also be based on the size of the current 3D model, both in terms of the number of 3D points in the point cloud P and the number of images already inserted in the 3D model.

If the current 3D model is comparatively small, for example when the number of 3D points |P| in the point cloud is below some threshold value τ₃, that is when |P|<τ₃, and the number of images already inserted in the 3D model is below some threshold value τ₄, then the next image is selected from the queue of non-tested images 187. One motivation for this is that inserting an image with an incorrect pose at an early stage will introduce an error in the 3D model that will propagate through more images. Moreover, since the 3D model is small, an incorrect pose, and consequently, the incorrect newly triangulated 3D points will have a higher impact on the BA optimization. That is, the 3D model at an early stage is more sensitive to errors from an incorrect pose.

On the other hand, if the model is larger (i.e., |P|>τ₃ and the number of images already inserted in the 3D model is above τ₄), a new attempt can be made to insert an already tested image (i.e., to select the next image from the queue of tested images 189). One motivation for this is that the impact of the erroneous pose and 3D point estimates will be lower in the BA optimization, which can handle them by the introduction of a reweighting of those measures and/or exploiting robust kernels in the cost function.

In some examples, a new attempt can be made to insert an already tested image (i.e., to select the next image from the queue of tested images 189) if τ₂<λₘᵢₙ<τ₁ for the image under consideration.

Examples of when to discard an image will be disclosed next. In general terms, discarding an image implies that the image is removed from the queue of tested images 189 without being tested again.

One motivation for discarding images is that if images are never discarded, there could be a risk that a loop is entered where a given image already in the queue of tested images 189 is inserted again in the queue of tested images 189 if the given image again fails to pass the certificate test. Hence, there is a risk that the given image will continue to be tested, only to fail the certificate test and then be re-inserted in the queue of tested images 189. This loop can process unless the given image eventually is discarded.

In some examples, the image is discarded in case an image has already been tested more than τ₅ times. This can be motivated by the fact that if the insertion of an image keeps failing to pass the certificate test, there is a high probability that the information from that image (i.e., the keypoints) are not matched properly and/or that they lead to degenerate solutions (e.g., all 3D points are colinear).

In some examples, all images in the queue of tested images 189 are discarded when the queue of non-tested images 187 has been emptied.

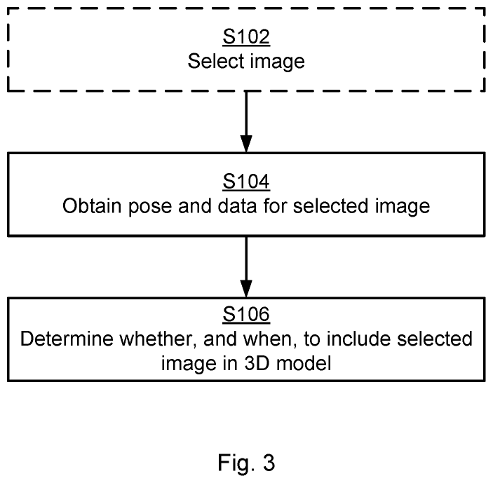

FIG. 3 is a flowchart illustrating embodiments of methods for determining whether or not to include an image in a 3D model of a scene. The methods are performed by the image processing device 500, 600. The methods are advantageously provided as computer programs 720. The method is repeatedly performed for images obtained from an image scan of the scene that have not already been included in the 3D model. The method for each iteration k=1:K comprises performing actions S104 and S106.

S104: The image processing device 500, 600 obtains a pose as determined for an image selected for iteration k and data used to compute the pose for the selected image.

S106: The image processing device 500, 600 determines, depending on whether a value for the image as computed as a function of the pose and the data for the selected image fulfils a quality criterion or not, whether, and when, to include the selected image in the 3D model. The selected image is included in the 3D model for iteration k when the value fulfils the quality criterion. The selected image is not included in the 3D model for iteration k when the value fails to fulfil the quality criterion.

Embodiments relating to further details of determining whether or not to include an image in a 3D model of a scene as performed by the image processing device 500, 600 will now be disclosed with continued reference to FIG. 3.

As noted above, in some examples, the method is performed as part of an incremental structure-from-motion process for determining the 3D model.

In some aspects, there is made a selection of which image to be selected for the current iteration. hence, in some embodiments, the image processing device 500, 600 is configured to perform (optional) step S102:
S102: The image processing device 500, 600 selects, based on a selection criterion, the image from the images obtained from the image scan.

Different examples of selection criteria have been listed above and apply here as well. That is, in some embodiments, the selection criterion pertains to most co-visible 3D points of all the images obtained from the image scan that have not already been included in the 3D model. In some embodiments, the selection criterion pertains to most co-visible 2D points, with respect to images already included in the 3D model, of all the images obtained from the image scan that have not already been included in the 3D model. In some embodiments, the selection criterion pertains to maximally distributed 2D points or 3D points in the image of all the images obtained from the image scan that have not already been included in the 3D model.

In some aspects, the image processing device 500, 600 actually determines the pose for the selected image. That is, in some embodiments, obtaining the pose involves determining the pose for the selected image. In other aspects, the pose has already been determined and is merely acquired from some storage, or buffer, by the image processing device 500, 600 in step S104.

In this respect, there could be different criteria according to which the pose is determined. In some aspects, as disclosed above, the pose is determined to minimize the distance between the 3D line corresponding to the reprojection ray of the observed 2D point and the 3D point. That is, in some embodiments, the pose is determined that minimizes a distance between a 3D line corresponding to a reprojection ray of an observed 2D point in the selected image and a position of the 3D point as projected to the selected image, where the position of the 3D point is given by the pose.

In other aspects, as disclosed above, the pose is determined to minimize the reprojection error. That is, in some embodiments, the pose is determined that minimizes a distance between an observed 2D point in the selected image and a position of the 3D point as projected to the selected image, where the position of the 3D point is given by the pose.

As disclosed above, it is determined depending on whether a value for the image as computed as a function of the pose and the data for the selected image fulfils a quality criterion or not, whether, and when, to include the selected image in the 3D model. There could be different such quality criteria.

In some aspects, the quality criterion corresponds to a global optimum. In particular, in some embodiments, the quality criterion pertains to determining if the solution is a global optimum or not of the function.

Further in this respect, there could be different types of functions of the pose and the data for the selected image.

In some embodiments, the function pertains to a Hessian matrix computed for the pose and the data for the selected image. As noted above, in some examples, to consider the solution as optimal, λₘᵢₙ is required to be larger than a fixed, negative threshold value τ₁. Therefore, according to an embodiment, the quality criterion is fulfilled when the smallest non-negative eigenvalue of the Hessian matrix is larger than a threshold value. That is, according to this embodiment, the selected image is included in the 3D model for the current iteration when the smallest non-negative eigenvalue of the Hessian matrix is larger than a threshold value.

In some embodiments, the function pertains to a convex relaxation of average reprojection error and orthonormal matrix constraints. In this respect, the original problem can be regarded as to minimize the average reprojection error given that the camera rotation needs to be a rotation matrix. Using Lagrange multipliers, a problem can be defined with a cost function that satisfies the constraints. Since this function is not convex, relaxation can be used to obtain a convex problem which is easier to solve.

In further detail, the PnP problem can be formulated as an optimization problem. The optimization problem seeks the translation t (a 3D vector) and the rotation R (as a 3×3 matrix) that minimizes a cost function ƒ(R, t) defined as:

$$f ( R , t ) = {\sum }_{i = 1}^{N} {‖ ( {I}_{3} - {x}_{i} {x}_{i}^{T} ) ( R {P}_{i} + t ) ‖}^{2}$$

where Pᵢ is the (known) i:th 3D point and xᵢ (which has unit norm) is its (known) observation in the image. Further, N is the number of pairs point-observation and I₃ is a 3×3 identity matrix. The rotation needs to have orthonormal rows, meaning that RR^{T}=I₃, which provides 6 independent constraints. This relation also includes reflections, but it works well in practice while simplifying the formulation.

The Hessian is a matrix that depends on (i) the cost ƒ(R, t), (ii) the constraints RR^{T}=I₃, and (iii) the Lagrange multipliers. It is associated with a convex relaxation of the original problem, known as the dual problem. An example of this relaxation for the relative pose problem is presented by Mercedes Garcia-Salguero, Jesus Briales, and Javier Gonzalez-Jimenez in “Certifiable Relative Pose Estimation”, https://arxiv.org/pdf/2003.13732.pdf, as available per 21 Mar. 2023. The Lagrange multipliers, as used here, depend linearly on the potential solution. The certifier first computes these multipliers in closed form and forms the Hessian. Then, it is checked whether the Hessian has all its eigenvalues non-negative (up to a small tolerance) or not, by computing its eigenvalue decomposition and checking the smallest eigenvalue λₘᵢₙ. The solution is then regarded as certified if this eigenvalue is non-negative.

In further detail, the Hessian matrix H∈ [symbol] ^{12×12} depends on the cost C∈ [symbol] ^{12×12}, the constraints, and the multipliers Al∈ [symbol] ^{12×12}, as H=C−Al. The cost C has the form

$$C = [ \begin{matrix}{C}_{r} & {C}_{tr} \\ {C}_{tr}^{T} & {C}_{t}\end{matrix} ] , where$$

$${C}_{r} = {\sum }_{i = 1}^{N} {( {P}_{i}^{T} ⊗ {I}_{3} )}^{T} ( {I}_{3} - {x}_{i} {x}_{i}^{T} ) ( {P}_{i}^{T} ⊗ {I}_{3} ) ∈ {ℝ}^{9 \times 9} ,$$

where “⊗” denotes the Kronecker product, where

$${C}_{tr} = {\sum }_{i = 1}^{N} ( {I}_{3} - {x}_{i} {x}_{i}^{T} ) ( {P}_{i}^{T} ⊗ {I}_{3} ) ∈ {ℝ}^{9 \times 3} ,$$

and where

$${C}_{t} = {\sum }_{i = 1}^{N} ( {I}_{3} - {x}_{i} {x}_{i}^{T} ) ∈ {ℝ}^{3 \times 3} .$$

These matrices come from the minimized error

$${e}_{i} = ( {I}_{3} - {x}_{i} {x}_{i}^{T} ) ( {RP}_{i} + t ) .$$

For the constraints and the six multipliers (I₁, . . . , I₆) in Al, we have:

$$Al = [ \begin{matrix}{l}_{1} {l}_{2} {I}_{3} & 0.5 {l}_{4} {l}_{3} {I}_{3} & 0.5 {l}_{5} {l}_{3} {I}_{3} & {0}_{3 \times 3} \\ 0.5 {l}_{4} {l}_{3} {I}_{3} & {l}_{2} {l}_{3} {I}_{3} & 0.5 {l}_{6} {l}_{3} {I}_{3} & {0}_{3 \times 3} \\ 0.5 {l}_{5} {l}_{3} {I}_{3} & 0.5 {l}_{6} {l}_{3} {I}_{3} & {l}_{3} {l}_{3} {I}_{3} & {0}_{3 \times 3} \\ {0}_{3 \times 3} & {0}_{3 \times 3} & {0}_{3 \times 3} & {0}_{3 \times 3}\end{matrix} ] .$$

As noted above, there can be different ways to process the selected image once it has been determined that the selected image is not to be included in the 3D model for the current iteration. Aspects relating thereto will be disclosed next.

In some aspects, either a new attempt is made to insert the selected image after the 3D model has grown, or the selected image is discarded. That is, in some embodiments, when the selected image is not included in the 3D model for iteration k, the selected image is either included in the 3D model for a later iteration or never included in the 3D model.

Further aspects relating to when to make a new attempt to insert the selected image and when to discard the selected image based on the above examples will be disclosed next.

In some embodiments, the selected image is only considered for inclusion in the 3D model when at least one further image has been included in the 3D model.

In some embodiments, when the selected image is considered for inclusion in the 3D model, information is provided regarding location of keypoints in the selected image that could not be matched to the 3D model when the pose for the selected image was determined in a previous iteration.

In some embodiments, the selected image is only considered for inclusion in the 3D model when at least a predetermined number of images have been included in the 3D model.

In some embodiments, the selected image is only considered for inclusion in the 3D model when the value differs at most a threshold value from fulfilling the quality criterion. This could be the case where, as in the above example, τ₂<λₘᵢₙ<τ₁.

In some embodiments, the selected image is not again considered for inclusion in the 3D model (i.e., the selected image is discarded) when the selected image already has been considered for inclusion in the 3D model at least a predetermined number of times.

In some embodiments, the selected image is not again considered for inclusion in the 3D model (i.e., the selected image is discarded) when all images obtained from the image scan have been considered for inclusion in the 3D model.

The threshold values as defined above can be selected according to experiments, simulations, by running one or more optimization algorithms, be set according to tabulated values, and/or be selected according to design choices.

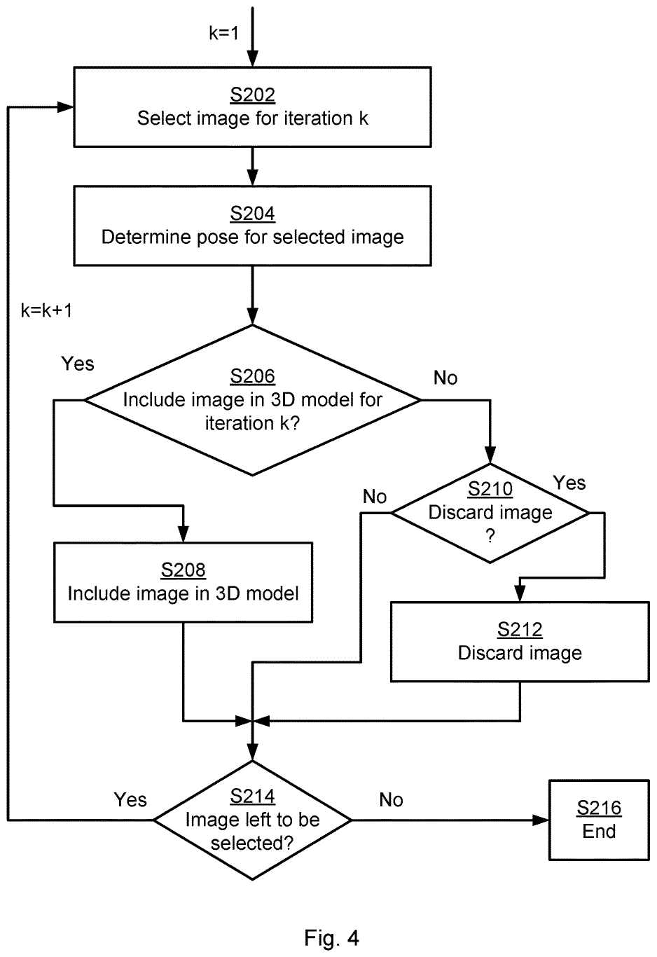

One embodiment of a method for determining whether or not to include an image in a 3D model of a scene as based on at least some of the above embodiments, aspects, and examples will be disclosed next with reference to the flowchart of FIG. 4. The method is performed for iterations k=1:K.

The value of k is initialized; k=1.

S202: An image to possibly be included in the 3D model is selected for iteration k. Different selection criteria have been disclosed above, and any such selection criteria can be used here. Depending on the iteration, the image can be selected from either of the queues 187 or 189.

S204: The pose is determined for the selected image. Examples of how to determine the pose for an image have been disclosed above and any can be used here.

S206: It is checked if the selected image is to be included in the 3D model for the current iteration k or not. If yes, step S208 is entered. Else, step S210 is entered. Examples of how to perform the check in step S206 have been disclosed above and any can be used here.

S208: The selected image is included in the 3D model. Examples of how to include the selected image in the 3D model have been disclosed above and any can be used here.

S210: It is checked whether the selected image is to be discarded or not. If yes, step S212 is entered. Else, step S214 is entered. Examples of how to perform the check in step S210 have been disclosed above and any can be used here.

S212: The selected image is discarded.

S214: It is checked if there are any images left (i.e., if there are any images left that have neither been included in the 3D model nor discarded, and thus if any of the queues 187 or 189 are not empty). If yes, the value of k is incremented; k=k+1 and step S202 is entered again. Else, step S216 is entered.

S216: There are no more images to consider for inclusion in the 3D model. The current 3D model and poses represent the final 3D model and poses.

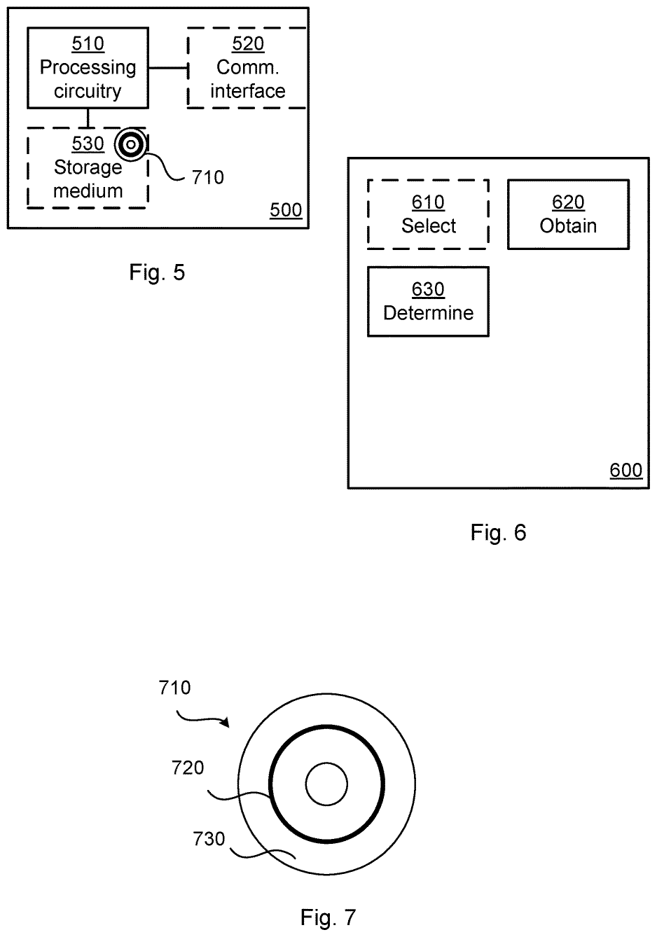

FIG. 5 schematically illustrates, in terms of a number of functional units, the components of an image processing device 500 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7), e.g., in the form of a storage medium 230. The processing circuitry 210 may further be provided as at least one application specific integrated circuit (ASIC), or field programmable gate array (FPGA).

Particularly, the processing circuitry 210 is configured to cause the image processing device 500 to perform a set of operations, or steps, as disclosed above. For example, the storage medium 230 may store the set of operations, and the processing circuitry 210 may be configured to retrieve the set of operations from the storage medium 230 to cause the image processing device 500 to perform the set of operations. The set of operations may be provided as a set of executable instructions.

Thus, the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The image processing device 500 may further comprise a communications (comm.) interface 220 at least configured for communications with other entities, functions, nodes, and devices. As such the communications interface 220 may comprise one or more transmitters and receivers, comprising analogue and digital components. The processing circuitry 210 controls the general operation of the image processing device 500, e.g., by sending data and control signals to the communications interface 220 and the storage medium 230, by receiving data and reports from the communications interface 220, and by retrieving data and instructions from the storage medium 230. Other components, as well as the related functionality, of the image processing device 500 are omitted in order not to obscure the concepts presented herein.

FIG. 6 schematically illustrates, in terms of a number of functional modules, the components of an image processing device 600 according to an embodiment. The image processing device 600 of FIG. 6 comprises a number of functional modules; an obtain module 620 configured to perform step S104, and a determine module 630 configured to perform step S106. The image processing device 600 of FIG. 6 may further comprise a number of optional functional modules, such as a select module 610 configured to perform step S102. In general terms, each functional module 610:630 may in one embodiment be implemented only in hardware and in another embodiment with the help of software, i.e., the latter embodiment having computer program instructions stored on the storage medium 230 which when run on the processing circuitry makes the image processing device 500 perform the corresponding steps mentioned above in conjunction with FIG. 6. It should also be mentioned that even though the modules correspond to parts of a computer program, they do not need to be separate modules therein, but the way in which they are implemented in software is dependent on the programming language used.

Preferably, one or more or all functional modules 610:630 may be implemented by the processing circuitry 210, possibly in cooperation with the communications interface 220 and/or the storage medium 230. The processing circuitry 210 may thus be configured to from the storage medium 230 fetch instructions as provided by a functional module 610:630 and to execute these instructions, thereby performing any steps as disclosed herein.

The image processing device 500, 600 may be provided as a standalone device or as a part of at least one further device. A first portion of the instructions performed by the image processing device 500, 600 may be executed in a first device, and a second portion of the of the instructions performed by the image processing device 500, 600 may be executed in a second device; the herein disclosed embodiments are not limited to any particular number of devices on which the instructions performed by the image processing device 500, 600 may be executed. Hence, the methods according to the herein disclosed embodiments are suitable to be performed by an image processing device 500, 600 residing in a cloud computational environment. Therefore, although a single processing circuitry 210 is illustrated in FIG. 5 the processing circuitry 210 may be distributed among a plurality of devices, or nodes. The same applies to the functional modules 610:630 of FIG. 6 and the computer program 720 of FIG. 7.

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-24. (canceled)

25. A method for determining whether to include an image in a three-dimensional (3D) model of a scene, wherein the method is performed iteratively by an image processing device for images obtained from an image scan of the scene that have not already been included in the 3D model, wherein the method for each iteration k=1:K comprises:
obtaining a pose as determined for an image selected for iteration k and data used to compute the pose for the selected image; and
determining whether, and when, to include the selected image in the 3D model, wherein:
the determining is based on a quality criterion and on a value computed as a function of the pose and of the data used to compute the pose,
the selected image is included in the 3D model for iteration k when the value fulfils the quality criterion, and
the selected image is not included in the 3D model for iteration k when the value fails to fulfil the quality criterion.

26. The method according to claim 25, further comprising selecting, for iteration k based on a selection criterion, the image from the images obtained from the image scan.

27. The method according to claim 26, wherein the selection criterion pertains to most co-visible 3D points of all the images obtained from the image scan that have not already been included in the 3D model.

28. The method according to claim 26, wherein the selection criterion pertains to most co-visible two-dimensional (2D) points, with respect to images already included in the 3D model, of all the images obtained from the image scan that have not already been included in the 3D model.

29. The method according to claim 26, wherein the selection criterion pertains to maximally distributed two-dimensional (2D) points or 3D points in the image of all the images obtained from the image scan that have not already been included in the 3D model.

30. The method according to claim 25, wherein obtaining the pose comprises determining the pose for the selected image based on minimizing a distance to a 3D point as projected to the selected image, wherein the position of the 3D point is given by the pose.

31. The method according to claim 30, wherein the determined pose minimizes a distance between a 3D line corresponding to a reprojection ray of an observed 2D point in the selected image and the position of the 3D point as projected to the selected image.

32. The method according to claim 30, wherein the determined pose minimizes a distance between an observed 2D point in the selected image and the position of the 3D point as projected to the selected image.

33. The method according to claim 25, wherein the quality criterion pertains to a global optimum of the function.

34. The method according to claim 25, wherein the function pertains to a Hessian matrix computed for the pose and for the data for the selected image.

35. The method according to claim 34, wherein the quality criterion is fulfilled when a smallest non-negative eigenvalue of the Hessian matrix is larger than a threshold value.

36. The method according to claim 25, wherein the function pertains to a convex relaxation of average reprojection error and orthonormal matrix constraints.

37. The method according to claim 25, wherein when the selected image is not included in the 3D model for iteration k, the selected image is selectively considered for inclusion in the 3D model during iterations after iteration k based on one or more conditions.

38. The method according to claim 37, wherein the selected image is only considered for inclusion in the 3D model during iterations after iteration k when at least one further image has been included in the 3D model.

39. The method according to claim 37, wherein when the selected image is considered for inclusion in the 3D model during iterations after iteration k, information is provided regarding location of keypoints in the selected image that could not be matched to the 3D model when the pose for the selected image was determined in a previous iteration.

40. The method according to claim 37, wherein the selected image is considered for inclusion in the 3D model during iterations after iteration k only when at least a predetermined number of images have been included in the 3D model.

41. The method according to claim 37, wherein the selected image is considered for inclusion in the 3D model during iterations after iteration k only when the value determined for iteration k fails to fulfil the quality criterion by no more than a threshold value.

42. The method according to claim 37, wherein the selected image is not considered for inclusion in the 3D model during iterations after iteration k when the selected image already has been considered for inclusion in the 3D model at least a predetermined number of times during iteration k and iterations before iteration k.

43. The method according to claim 37, wherein the selected image is not considered for inclusion in the 3D model during iterations after iteration k when all images obtained from the image scan have been considered for inclusion in the 3D model during iteration k and iterations before iteration k.

44. The method according claim 25, wherein the method is performed as part of an incremental structure-from-motion process for determining the 3D model.

45. An image processing device configured to perform iterative operations for images obtained from an image scan of a scene that have not already been included in a three-dimensional (3D) model of the scene, wherein the image processing device comprises processing circuitry configured to perform the following operations for each iteration k=1:K:
obtain pose as determined for an image selected for iteration k and data used to compute the pose for the selected image; and
determine whether, and when, to include the selected image in the 3D model, wherein:
the determining is based on a quality criterion and on a value computed as a function of the pose and of the data used to compute the pose,
the selected image is included in the 3D model for iteration k when the value fulfils the quality criterion, and
the selected image is not included in the 3D model for iteration k when the value fails to fulfil the quality criterion.
